(19) United States
(12) Patent Application Publication
(10) Pub. No.: US 2024/0095531 A1
(43) Pub. Date: Mar. 21, 2024

(54) METHOD AND COMPUTER SYSTEM FOR TRAINING A NEURAL NETWORK MODEL

(71) Applicant: HUAWEI TECHNOLOGIES CO., LTD., Shenzhen (CN)

(72) Inventors: Lei Jiang, Moscow (RU); Shihai Xiao, Hangzhou (CN)

(21) Appl. No.: 18/521,763

(22) Filed: Nov. 28, 2023

Related U.S. Application Data
(63) Continuation of application No. PCT/RU2021/000226, filed on May 28, 2021.

(51) Int. Cl. G06N 3/08

(52) U.S. Cl. CPC G06N 3/08

(57) ABSTRACT

A method trains a neural network model in a computer system. The neural network model includes one or more layers each including one or more neurons. The one or more layers include at least one first layer and one last layer. Each neurons are configured to perform forward propagation of one or more input values by applying weights to the one or more input values and generating an output value based on a function applied to the sum of the weighted input values. The neurons of any given layer, but the last layer, of the one or more layers are connected with the one or more neurons of a consecutive layer. The neurons of any given layer, but the first layer, of the one or more layers are connected with the one or more neurons of a preceding layer.

### CROSS-REFERENCE TO RELATED APPLICATIONS

This application is a continuation of International Application No. PCT/RU2021/000226, filed on May 28, 2021, the disclosure of which is hereby incorporated by reference in its entirety.

### FIELD

The disclosure relates to a neural network model, and more particularly, a method and a computer system for training a neural network model with improved classification precision and robustness of the neural network model.

### BACKGROUND

A neuron is a basic unit in a neural network model that includes a specific quantity of inputs and an offset value. The inputs of the neuron are multiplied by a corresponding weight to obtain an output of the neuron. Normally, the output of the neuron is obtained using an activation function of the neuron.

One or more neurons are connected in a specific manner to form a neural network model. Currently, a gradient descent algorithm is a mainstream neural network training algorithm that includes a back propagation algorithm to obtain a gradient. The neural network models are used to perform complex tasks that output a result based on a quality of training of the neural network. The training requires a large amount of training data and algorithms. Generation of the large amount of training data is an expensive process and may include manual processing. Some of the neural network models are trained using iterative optimization algorithms that include calculation of gradient and iteratively updating neural network model parameters with some data classification techniques. Those data classification uses only a part of trained data classification layers and part of connected layers, which may not arrive at a classification precision of the neural network model.

Existing solutions include a dropout in the neurons that indicate absence from a calculation process of the neural network model with specific probability in a training process, but presence in the calculation process of the neural network in a test time or reasoning and resolving time. But in the dropout, a neuron removing process is relatively performed in the training process, based on probability. In a general visual task, use effects of the dropout at a convolutional layer are not greater, and the precision of the neural network model is not improved as the dropout only indicates the presence and absence of the calculation process.

Therefore, there arises a need to address the aforementioned technical drawbacks in known techniques or technologies in training a neural network model with improved classification precision and robustness of the neural network model.

### SUMMARY

It is an object of the disclosure to provide a method and a computer system for training a neural network model with improved classification precision and robustness of the neural network model while avoiding one or more disadvantages of prior art approaches.

This object is achieved by the features of the independent claims. Further, implementation forms are apparent from the dependent claims, the description, and the figures.

The disclosure provides a method and a computer system for training a neural network.

According to a first aspect, there is provided a method for training a neural network model in a computer system. The neural network model includes a plurality of layers each including one or more neurons. The plurality of layers include at least one first layer and one last layer. Each neurons are being configured to perform forward propagation of one or more input values by applying weights to the one or more input values and generating an output value based on a function applied to the sum of the weighted input values. The neurons of any given layer, but the last layer, of the plurality of layers being connected with the one or more neurons of a consecutive layer. The neurons of any given layer, by the first layer, of the plurality of layers being connected with the one or more neurons of a preceding layer. The output of one given neuron of a preceding layer is used as an input value of the neurons of a consecutive layer connected with the given neuron. The method includes a forward propagation step including (a) inputting initial input values to the neurons of the first layer, and (b) performing forward propagation from the neurons of the first layer through the neurons of the consecutive layers, until the neurons of the last layer, to obtain output values of the neurons of the last layer. The method includes a back propagation step including (a) measuring errors between the output values and expected values of the neurons of the last layer, and (b) for each given layer, but the last layer, until the first layer, measuring errors between the output values and the expected values of the neurons of the given layer, and performing back propagation by determining weight updates values for the weight of the neurons of the given layer, based on measured errors between the output values and expected values of the neurons of the consecutive layer, and changing the weight values of the neurons of the given layer based on the weight update values. Performing of the back propagation includes determining inhibited neurons and uninhibited neurons amongst the neurons of the given layer based on measurement of errors between the output values and expected values of the neurons of the given layer, and changing the weight values only of the uninhibited neurons of the given layer.

The method includes a lateral inhibition mechanism into a training mechanism for training the neural network model that enables to perform the forward propagation and the backward propagation with inhibition once in each epoch.

The advantage is that the method improves precision and robustness of the neural network model using a data enhancement method based on inhibition information. The one or more neurons that are unrelated to a result may not be included in the weight update. The method trains the neural network model with the forward propagation step and the back propagation step, thereby improving the precision of an image classification neural network and a convergence rate of training.

Optionally, determining the inhibited and uninhibited neurons amongst the neurons of the given layer includes using the measured errors between the output values and expected values to determine a contribution of each neurons of the given layers to the output values and deciding whether a neuron is inhibited or uninhibited based on the contribution.

Optionally, the method further includes inputting a plurality of sets of input values to the neurons of the given layer and performing the forward propagation on neurons of the given layer to obtain corresponding sets of output values of the neurons of the given layer, and determining weight updates values for the weight of the neurons of the given layer and inhibited neurons and uninhibited neurons amongst the neurons of the given layer, based on measurement of errors between the sets of output values and corresponding sets of expected values.

Optionally, the neural network model includes n layers, with n≥2. The layers are divided in a first group of layers gathering first p layers, with 0<p<n, and a second group of layers gathering last n-p layers. Optionally, the method is performed separately on the first group of layers and on the second group of layers.

Optionally, the neural network model being a model for image classification in the computer system. The sets of input values corresponding to image pixels values, a connexion path from one neuron of the first layer to one neuron of the last layer in the network corresponding to a channel from one input pixel value to one output pixel value. Optionally, determining the inhibited neurons and the uninhibited neurons amongst the neurons of the given layer, including determining a two dimensional mask based on measurement of errors between the output values and expected values. Each element of the two dimensional mask corresponding to a neuron in the given layer and includes an inhibition information. Optionally, propagating the weight updates values to change the weight values only of the uninhibited neurons of the given layer includes applying the mask to avoid the weights of the inhibited neurons, and allow the weights of the uninhibited neurons, to be changed depending on the corresponding inhibition information.

The training mechanism of the method may be used as an application on a platform such as a general-purpose server, a personal computer, an embedded processing platform, or may be embedded and hardened into an Application-specific integrated circuit (ASIC)/field-programmable gate array (FPGA).

According to a second aspect, there is provided a computer system for training a neural network model. The neural network model includes a plurality of layers each including one or more neurons. The plurality of layers include at least one first layer and one last layer. Each neurons are being configured to perform forward propagation of one or more input values by applying weights to one or more input values and generating an output value based on a function applied to the sum of the weighted input values. The neurons of any given layer, but the last layer, of the plurality of layers being connected with one or more neurons of a consecutive layer. The neurons of any given layer, but the first layer, of the plurality of layers being connected with one or more neurons of a preceding layer, such that the output of one given neuron of one given layer is used as an input value of the neurons of the consecutive layer connected with the given neuron. The computer system includes a forward calculation module and a backward calculation module. The forward calculation module configured to allow inputting of initial input values to the neurons the first layer and to perform forward propagation from the neurons of the first layer through the neurons of the consecutive layers, until the neurons of the last layer, to obtain output values of the neurons of the last layer. The backward calculation module is configured to measure errors between output values and expected values of the neurons of the last layer. The backward calculation module configured for each given layer, but the last layer, until the first layer, to measure errors between the output values and expected values of the neurons of the given layer, and to determine weight updates values for the weight of the neurons of the given layer, based on measured errors between the output values and expected values of the neurons of the consecutive layer, and to change the weight values of the neurons of the given layer based on the weight update values. The backward calculation module is further configured to determine inhibited neurons and uninhibited neurons amongst the neurons of the given layer based on measurement of errors between the output values and expected values of the given layer, and to change the weight values only of the uninhibited neurons of the given layer.

The computer system includes a lateral inhibition mechanism that enables stimulated neurons to inhibit an activity of nearby neurons. Training of the neural network model in the computer system includes the lateral inhibition mechanism that enables to perform the forward propagation and the backward propagation with inhibition once in each epoch.

The advantage is that the computer system improves precision and robustness of the neural network model using a data enhancement method based on inhibition information. The one or more neurons that are unrelated to a result may not be included in the weight update. The computer system trains the neural network model with the forward calculation module and the backward calculation module, thereby improving the precision of an image classification neural network and a convergence rate of training.

Optionally, the backward calculation module is further configured to use errors measured between the output values and expected values to determine a contribution of each neurons of the given layers to the output values and to decide whether a neuron is inhibited or uninhibited based on the contribution.

Optionally, the forward calculation module is further configured to allow inputting of a plurality of sets of input values to the neurons of the given layer and to perform forward propagation on neurons of the given layer to obtain corresponding sets of output values of the neurons of the given layer. Optionally the backward calculation module is further configured to determine weight updates values for the weight of the neurons of the given layer and inhibited neurons and uninhibited neurons amongst the neurons of the given layer, based on measurement of errors between the sets of output values and corresponding sets of expected values.

Optionally, the neural network model includes n layers, with n≥2. The layers are divided in a first group gathering the first p layers, with 0<p<n, and a second group of layers gathering the last n-p layers. Optionally, the computer system being further configured to run iteratively the forward calculation module and the backward calculation module, separately on the first group of layers and on the second group of layers.

Optionally, the neural network model being a model for image classification, the sets of input values corresponding to image pixels values, a connexion path from one neuron of the first layer to one neuron of the last layer in the network corresponding to a channel from one input pixel value to one output pixel value. Optionally, the backward calculation module is further configured to determine a two dimensional mask based on measurement of errors between the output values and expected values, each element of the two dimensional mask corresponding to a neuron in the given layer and comprising an inhibition information, and is further configured to, when propagating the weight updates values to change the weight values only of the uninhibited neurons of the given layer, apply the mask to avoid the weights of the inhibited neurons, and allow the weights of the uninhibited neurons, to be changed depending on the corresponding inhibition information.

According to a third aspect, there is provided a computer-readable storage medium comprising instructions which, when executed by a computer, cause the computer to carry out the steps of the method according to any of the above method claims.

A technical problem in the prior art is resolved, where the technical problem concerns training a neural network model with improved classification precision and robustness of the neural network model.

Therefore, in contradistinction to the prior art, according to the method and the computing system, for improving precision and robustness of the neural network model using a data enhancement method based on inhibition information. The one or more neurons that are unrelated to a result may not be included in the weight update. The computer system trains the neural network model with the forward calculation module and the backward calculation module, thereby improving the precision of an image classification neural network and a convergence rate of training.

These and other aspects of the disclosure will be apparent from and the implementation(s) described below.

### BRIEF DESCRIPTION OF DRAWINGS

Implementations of the disclosure will now be described, by way of example only, with reference to the accompanying drawings, in which:

FIG. 1 is a block diagram that illustrates a computer system for training a neural network model in accordance with an implementation of the disclosure;

FIGS. 2A-2B are flow charts illustrating an iteration for training a neural network model in accordance with an implementation of the disclosure;

FIGS. 3A-3D illustrate exemplary graphical representations of a convolutional layer obtaining neuron inhibition information in accordance with an implementation of the disclosure;

FIG. 4 is an exemplary graphical representation that depicts one or more convolutional layers of a neural network model in accordance with an implementation of the disclosure;

FIGS. 5A-5B are flow diagrams that illustrate a method of training a neural network model in a computer system in accordance with an implementation of the disclosure; and

FIG. 6 is an illustration of a computing arrangement (e.g. a computer system) that is used in accordance with implementations of the disclosure.

### DETAILED DESCRIPTION

Implementations of the disclosure provide a method and a computer system for training a neural network model with improved classification precision and robustness of the neural network model.

To make solutions of the disclosure more comprehensible for a person skilled in the art, the following implementations of the disclosure are described with reference to the accompanying drawings.

Terms such as “a first”, “a second”, “a third”, and “a fourth” (if any) in the summary, claims, and foregoing accompanying drawings of the disclosure are used to distinguish between similar objects and are not necessarily used to describe a specific sequence or order. It should be understood that the terms so used are interchangeable under appropriate circumstances, so that the implementations of the disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units but may include other steps or units that are not expressly listed or that are inherent to such process, method, product, or device.

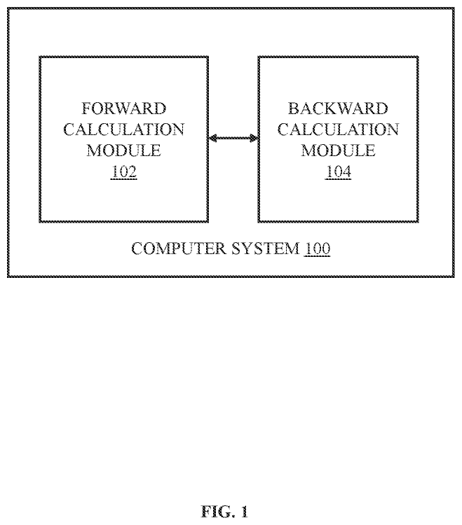

FIG. 1 is a block diagram that illustrates a computer system 100 for training a neural network model in accordance with an implementation of the disclosure. The neural network model includes one or more layers each including one or more neurons. The one or more layers include at least one first layer and one last layer. Each neurons are being configured to perform forward propagation of one or more input values by applying weights to the one or more input values and generating an output value based on a function applied to the sum of the weighted input values. The neurons of any given layer, but the last layer, of the one or more layers being connected with one or more neurons of a consecutive layer. The neurons of any given layer, but the first layer, of the one or more layers being connected with one or more neurons of a preceding layer, that the output of one given neuron of one given layer is used as an input value of the neurons of the consecutive layer connected with the given neuron. The computer system 100 includes a forward calculation module 102 and a backward calculation module 104. The forward calculation module 102 is configured to allow inputting of initial input values to the neurons of the first layer. The forward calculation module 102 is configured to perform forward propagation from the neurons of the first layer through the neurons of the consecutive layers, until the neurons of the last layer, to obtain output values of the neurons of the last layer. The backward calculation module 104 is configured to measure errors between output values and expected values of the neurons of the last layer. The backward calculation module 104 is configured to measure errors between the output values and expected values of the neurons of the given layer, and to determine weight updates values for the weight of the neurons of the given layer, based on measured errors between the output values and expected values of the neurons of the consecutive layer, and to change the weight values of the neurons of the given layer based on the weight update values for each given layer, but the last layer, until the first layer. The backward calculation module 104 is further configured to determine inhibited neurons and uninhibited neurons amongst the neurons of the given layer based on measurement of error between the output values and expected values of the given layer, and to change the weight values only of the uninhibited neurons of the given layer.

The advantage is that the computer system 100 improves precision and robustness of the neural network model using a data enhancement method based on inhibition information. The one or more neurons that are unrelated to a result may not be included in the weight update. The computer system 100 trains the neural network model with the forward calculation module 102 and the backward calculation module 104, thereby improving the precision of an image classification neural network and a convergence rate of training.

The computer system 100 may be any of a product including a server, a desktop computer, software on various dedicated computers, or an algorithm directly hardened into various computer devices.

The forward calculation module 102 enables inputting of the initial input values to the neurons of the first layer. The initial input values may be a feature from a training set or outputs from a previous layer. The initial input values may be provided using input nodes. The input nodes provide information from outside world to the neural network model. The forward calculation module 102 performs the forward propagation on the one or more layers to obtain the output values. The one or more neurons on the one or more layers of the neural network model are included in a calculation to obtain a LOSS while performing the forward propagation. The LOSS may be a sample error. The LOSS indicates a measure of a difference between an output of a neural network and a GRAND TRUTH for an input sample. Optionally, different neural networks may have different error measurement manners in different methods and designs that may be referred to as different loss functions in different designs.

The backward calculation module 104 measures errors between the output values and the expected values of the neurons. The backward calculation module 104 performs the back propagation that indicates error propagation on the one or more layers, layer by layer from back to front, to determine weight update values for the weight of the neurons of the current layer and change the weight values of the neurons of the current layer based on the weight update values.

Optionally, the backward calculation module 104 calculates a gradient of a current layer during the back propagation. Optionally, each layer in the back propagation is different in a gradient descent action and an error transmission action. Each neuron of the one or more neurons at the current layer is included in calculation to calculate a gradient of the LOSS for a weight and a gradient of the LOSS for an output of the neuron when the current layer is a specific convolutional layer. The specific convolutional layer may include a grid-like topology. The specific convolutional layer is applied to analyse visual imagery (i.e. an image) that enables image recognition and image classification. Optionally, the specific convolutional layer includes one or more hidden layers.

Optionally, the backward calculation module 104 determines the inhibited neurons and the uninhibited neurons based on, information about whether each neuron at the convolutional layer is inhibited. Optionally, the information is obtained based on the gradient of the LOSS for the output of the neuron.

Optionally, the back propagation is performed only on the uninhibited neuron. The weight update may be performed only on the uninhibited neuron. The error of the uninhibited neuron may be transmitted to a front layer. The computer system 100 is configured to check whether the back propagation of all layers is completed. The computer system 100 may enable the backward calculation module 104 to perform the backward propagation if the back propagation of all layers of the one or more layers is not completed.

Optionally, the backward calculation module 104 is further configured to use errors measured between the output values and expected values to determine a contribution of each neurons of the given layers to the output values and to decide whether a neuron is inhibited or uninhibited based on said the contribution.

Optionally, the forward calculation module 102 is further configured to allow inputting of one or more sets of input values to the neurons of the given layer and to perform forward propagation on neurons of the given layer to obtain corresponding sets of output values of the neurons of the given layer. Optionally, the backward calculation module 104 is further configured to determine weight updates values for the weight of the neurons of the given layer and inhibited neurons and uninhibited neurons amongst the neurons of the given layer, based on measurement of errors between the sets of output values and corresponding sets of expected values. The measurement of errors between the output of the neural network after the forward propagation and expected output of the neural network may be a loss function or a cost function.

Optionally, the neural network model includes n layers, with n≥2. The layers may be divided in a first group gathering the first p layers, with 0<p<n, and a second group of layers gathering the last n-p layers. Optionally, the computer system 100 being further configured to run iteratively the forward calculation module 102 and the backward calculation module 104, separately on the first group of layers and on the second group of layers.

Optionally, the neural network model being a model for image classification, the sets of input values corresponding to image pixels values, a connexion path from one neuron of the first layer to one neuron of the last layer in the network corresponding to a channel from one input pixel value to one output pixel value. Optionally, the backward calculation module 104 is further configured to determine a two dimensional mask based on measurement of errors between the output values and expected values, each element of the two dimensional mask corresponding to a neuron in the given layer and comprising an inhibition information. Optionally, the backward calculation module 104 is further configured to apply the mask to avoid the weights of the inhibited neurons, and allow the weights of the uninhibited neurons, to be changed depending on the corresponding inhibition information when propagating the weight updates values to change the weight values only of the uninhibited neurons of the given layer. Optionally, the backward calculation module 104 performs the back propagation to compute partial derivatives ∂C/∂w and ∂C/∂b of the cost function C with respect to any weight w or bias b in the neural network model. The cost function may be the measurement of the errors between the output of the neural network model after the forward propagation and the expected output values of the neural network model.

Optionally, the computer system 100 enables the training of the neural network model with data classification. The data classification may include object detection and semantic segmentation of the neural network model.

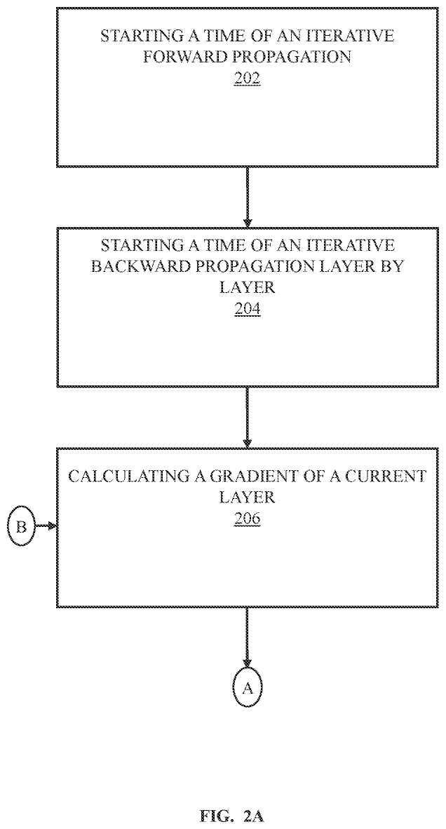

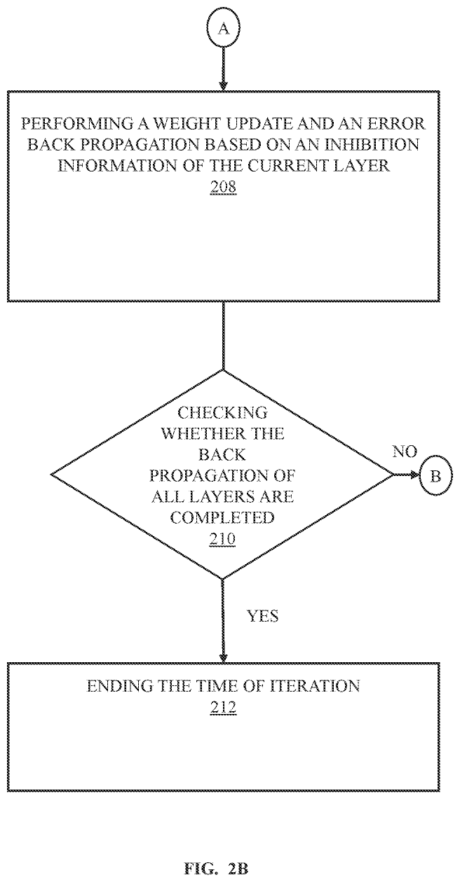

FIGS. 2A-2B are flow charts illustrating an iteration for training a neural network model in accordance with an implementation of the disclosure. At a step 202, a time of an iterative forward propagation is started. At a step 204, a time of an iterative back propagation is started layer by layer. At a step 206, a gradient of a current layer is calculated. Optionally, inhibition information of some neurons is obtained when the current layer is a conventional layer, in this time of the iterative back propagation based on gradient information of the current layer. At a step 208, a weight update and an error back propagation are performed based on the inhibition information of the current layer. At a step 210, the back propagation is checked whether all layers are completed. If yes, it goes to step 212, or else goes to step 206. At a step 212, the time of iteration is ended. Optionally, the iteration for training the neuron network continues until the back propagation of all the layers is completed.

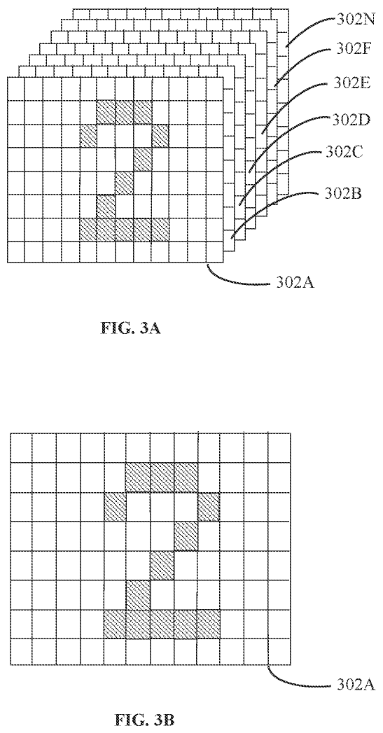

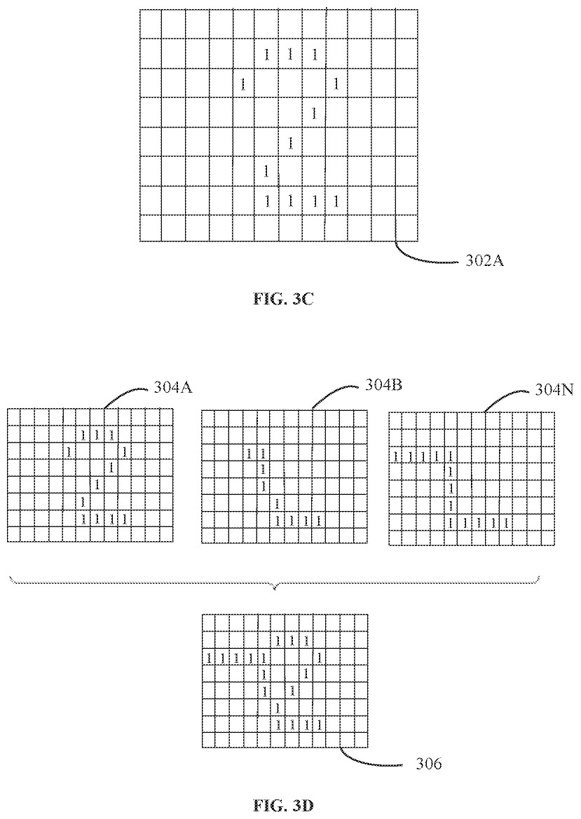

FIGS. 3A-3D illustrate exemplary graphical representations of a convolutional layer obtaining neuron inhibition information in accordance with an implementation of the disclosure. FIGS. 3A-3D illustrate the exemplary graphical representations of steps of obtaining the neuron inhibition information of a current layer from a current convolutional layer. The neuron inhibition information may be mask information of the layer. In FIG. 3A, exemplary graphical representation depicts one or more convolutional layers 302A-N of image classification networks. For example, the image classification networks may be ResNet and MobileNet. Each convolutional layer 302A-N generates a FeatureMap (FM) in a size of W*H*C. The W*H*C indicates a width (W) of the FM*a height (H) of the FM*a channel quantity of the FM (C). Optionally, the W*H*C vary with designs. Each convolutional layer includes W*H*C neurons. Forward propagation is performed on an input training image to obtain a LOSS, and then errors and gradients are calculated layer by layer with the forward propagation. Optionally, the errors and the gradients are calculated layer by layer according to a chain rule. Each layer receives an error transmitted from a back network layer to calculate a gradient of a current layer. Each convolutional layer can calculate, for each neuron of one or more neurons on one or more layers, a partial derivative of the LOSS for a weight of the neuron, a partial derivative of the LOSS for an offset, and a partial derivate of the LOSS for an output of the neuron.

In FIG. 3B, an exemplary graphical representation depicts an example convolutional layer 302A. A vector of a partial derivative of a LOSS of the convolutional layer 302A for an output of a neuron is obtained. Optionally, the obtained output of the neuron includes the vector of the partial derivative of the LOSS in a size of C*H*W of the convolutional layer. In a C dimension of the vector, L2 Norm, a number with a largest absolute value in C values at H*W locations is removed, which obtains a H*W two-dimensional vector.

The propagation includes applying a Laplacian of Gaussian to the H*W two-dimensional vector.

$$LOG ( x , y ) = - \frac{1}{{πσ}^{4}} [ 1 - \frac{{x}^{2} + {y}^{2}}{2 {σ}^{2}} ] {e}^{( - \frac{{x}^{2} + {y}^{2}}{2 {σ}^{2}} )}$$

The Laplacian of Gaussian includes operator parameters σ=Sigma and k=Kernel size, which are hyperparameters of an algorithm, to obtain an H*W two-dimensional vector.

In FIG. 3C, an exemplary graphical representation depicts the neuron inhibition information of the convolutional layer 302A. Optionally, a minimum value with a specific propagation is selected from the H*W two-dimensional vector. The specific propagation may be in a range of 1% to 10%. Optionally, a value with a larger absolute value is inhibited more, which can be selected from the H*W two-dimensional vector. 01 MASK in a size of H*W is generated based on locations of the values, as shown in FIG. 3C. Optionally, a location of a large value is zero. Optionally, a location of a small value is selected based on a proportion. Optionally, the proportion is a hyperparameter. The proportion may be 1 that determines the neuron inhibition information on the convolutional layer 302A. Optionally, the proportion determines the MASK information of the convolutional layer 302A.

In FIG. 3D an exemplary graphical representation depicts a batch of one or more MASKs 304A-N that are generated on the one or more convolutional layers. The batch of the one or more MASKs 304A-N generated on the one or more convolutional layers corresponding to one or more input images, are combined. Optionally, locations with a proportion of value 1 in the batch are a proportion of value 1 at H*W locations in the batch. The locations with the proportion of value 1 and the proportion of value 1 at H*W locations obtain a corresponding MASK 306 of a convolutional layer in the batch of training.

Optionally, a gradient, an error, and MASK information of a current layer are obtained at the convolutional layer is currently performed back propagation. During the back propagation, the weight update is performed for a weighted gradient that enables calculation of each neuron at each convolutional layer. The back propagation obtains only a neuron that is at a location at which the MASK is 1 through iterative calculation in the batch of training that performs the weight update based on the weight gradient. Optionally, a point location on the MASK corresponds to a neuron at a corresponding location in C channels of the current layer. The point location may be the location at which the MASK is 1 with the neuron.

The back propagation obtains an error of the neuron corresponding to the location at which the MASK is 1 at the current convolutional layer in the batch of training. The back propagation transmits the location at which the MASK is 1 at the current convolutional layer to a front layer and an error of the neuron in which the MASK is 0 is not transmitted to the front layer. Optionally, the back propagation enables the convolutional layer to obtain the MASK information in the batch of iterative training, which enables the weight update of the current convolutional layer and the transmission of the error to the front layer. Optionally, the inhibited neurons use ∂C/∂w and ∂C/∂b to update weights and bias in the neural network model. Optionally, the inhibited neurons back propagate the error to a last layer (i.e. l−1 of one or more convolutional layers) with a same error input, and the inhibited neurons back propagate a difference error from baseline to the front layer (i.e. l+1 of the one or more convolutional layers).

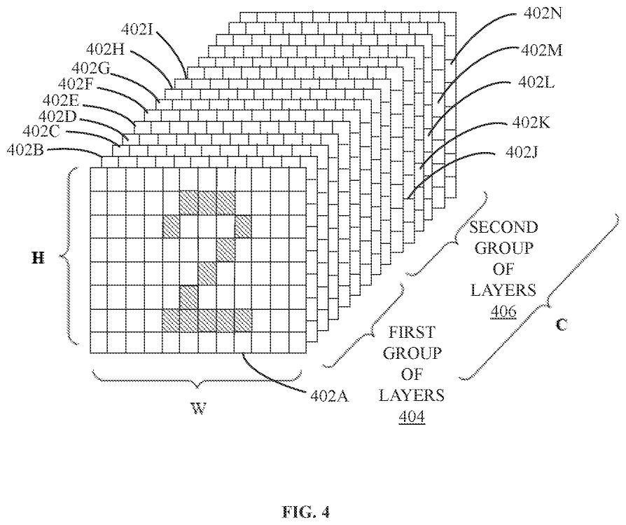

FIG. 4 is an exemplary graphical representation that depicts one or more convolutional layers 402A-N of a neural network model in accordance with an implementation of the disclosure. The neural network model may include the one or more convolutional layers 402A-N with N≥2. Optionally, a specific convolutional layer includes neurons in a size of C*H*W. Optionally, the neurons are grouped in dimension C. The one or more convolutional layers 402A-N along with the neurons are divided into one or more groups. The one or more groups include a first group of layers 404 and a second group of layers 406. The first group of layers 404 may include a first p layers, with 0<p<N. The second group of layers 406 may include a last N-p layers. The first group of layers 404 and the second group of layers 406 separately generate a corresponding H*W two-dimensional vector, and calculates a MASK with a forward propagation and a backward propagation. Optionally, a weight update and error transmission based on the MASK corresponding to the first group of layers 404 and the second group of layers 406 are calculated separately, thereby enabling accurate precision calculation.

Optionally, a computer system with a forward calculation module and a backward calculation module enables calculating of the MASK on the one or more convolutional layers 402A-N.

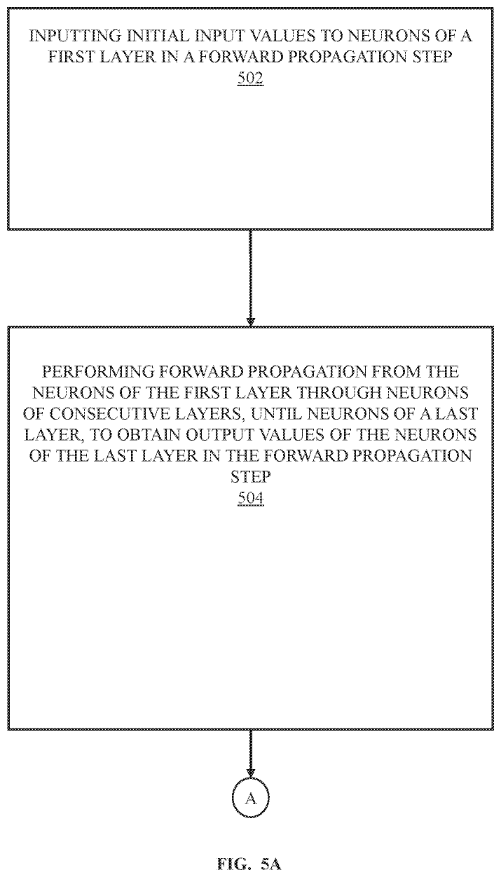

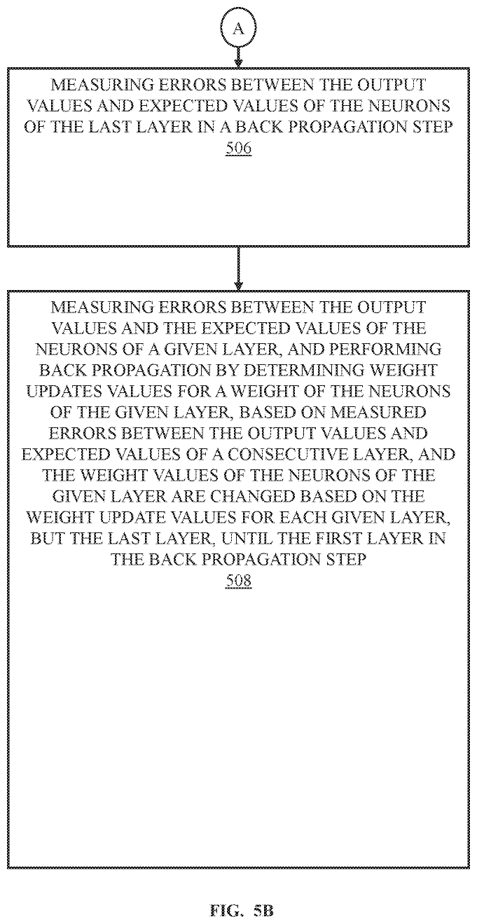

FIGS. 5A-5B are flow diagrams that illustrate a method of training a neural network model in a computer system in accordance with an implementation of the disclosure. The neural network model includes one or more layers each including one or more neurons. The one or more layers include at least one first layer and one last layer. Each neurons are being configured to perform forward propagation of one or more input values by applying weights to the one or more input values and generating an output value based on a function applied to the sum of the weighted input values. The neurons of any given layer, but the last layer, of the one or more layers being connected with the one or more neurons of a consecutive layer. The neurons of any given layer, by the first layer, of the one or more layers being connected with the one or more neurons of a preceding layer. The output of one given neuron of a preceding layer is used as an input value of the neurons of a consecutive layer connected with the given neuron. The method includes a forward propagation step and a back propagation step. At a step 502, initial input values are inputted to the neurons of the first layer in the forward propagation step. At a step 504, forward propagation from the neurons of the first layer is performed through the neurons of the consecutive layers, until the neurons of the last layer, to obtain output values of the neurons of the last layer in the forward propagation step. At a step 506, errors between the output values and expected values of the neurons of the last layer are measured in the back propagation step. At a step 508, errors between the output values and the expected values of the neurons of the given layer are measured, and back propagation is performed by determining weight updates values for the weight of the neurons of the given layer, based on measured errors between the output values and expected values of the neurons of the consecutive layer, and the weight values of the neurons of the given layer are changed based on the weight update values for each given layer, but the last layer, until the first layer in the back propagation step.

The advantage is that the method improves precision and robustness of the neural network model using a data enhancement method based on inhibition information. The one or more neurons that are unrelated to a result may not be included in the weight update. The method trains the neural network model with the forward propagation step and the back propagation step, thereby improving the precision of an image classification neural network and a convergence rate of training.

Optionally, determining the inhibited and uninhibited neurons amongst the neurons of the given layer includes using the measured errors between the output values and expected values to determine a contribution of each neurons of the given layers to the output values and deciding whether a neuron is inhibited or uninhibited based on the contribution.

Optionally, the method further includes inputting one or more sets of input values to the neurons of the given layer and performing the forward propagation on neurons of the given layer to obtain corresponding sets of output values of the neurons of the given layer, and determining weight updates values for the weight of the neurons of the given layer and inhibited neurons and uninhibited neurons amongst the neurons of the given layer, based on measurement of errors between the sets of output values and corresponding sets of expected values.

Optionally, the neural network model includes n layers, with n≥2. The layers are divided in a first group of layers gathering first p layers, with 0<p<n, and a second group of layers gathering last n-p layers. Optionally, the method is performed separately on the first group of layers and on the second group of layers.

Optionally, the neural network model being a model for image classification in the computer system. The sets of input values corresponding to image pixels values, a connexion path from one neuron of the first layer to one neuron of the last layer in the network corresponding to a channel from one input pixel value to one output pixel value. Optionally, determining the inhibited neurons and the uninhibited neurons amongst the neurons of the given layer, including determining a two dimensional mask based on measurement of errors between the output values and expected values. Each element of the two dimensional mask corresponding to a neuron in the given layer and includes an inhibition information. Optionally, propagating the weight updates values to change the weight values only of the uninhibited neurons of the given layer includes applying the mask to avoid the weights of the inhibited neurons, and allow the weights of the uninhibited neurons, to be changed depending on the corresponding inhibition information.

In an implementation, there is provided a computer-readable storage medium comprising instructions which, when executed by a computer, cause the computer to carry out the steps of the method according to any of the above method claims.

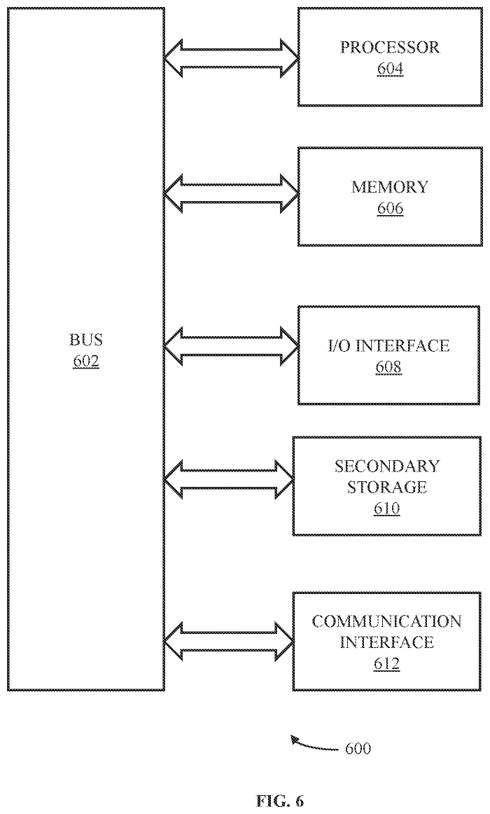

FIG. 6 is an illustration of an exemplary computing arrangement 600 (e.g. a computer system) in which the various architectures and functionalities of the various previous implementations may be implemented. As shown, the computing arrangement 600 includes at least one processor 604 that is connected to a bus 602, wherein the computing arrangement 600 may be implemented using any suitable protocol, such as PCI (Peripheral Component Interconnect), PCI-Express, AGP (Accelerated Graphics Port), HyperTransport, or any other bus or point-to-point communication protocol(s). The computing arrangement 600 also includes a memory 606.

Control logic (software) and data are stored in the memory 606 which may take the form of random-access memory (RAM). In the present description, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computing arrangement 600 may also include a secondary storage 610. The secondary storage 610 includes, for example, a hard disk drive and a removable storage drive, representing a floppy disk drive, a magnetic tape drive, a compact disk drive, digital versatile disk (DVD) drive, recording device, universal serial bus (USB) flash memory. The removable storage drive at least one of reads from and writes to a removable storage unit in a well-known manner.

Computer programs, or computer control logic algorithms, may be stored in at least one of the memory 606 and the secondary storage 610. Such computer programs, when executed, enable the computing arrangement 600 to perform various functions as described in the foregoing. The memory 606, the secondary storage 610, and any other storage are possible examples of computer-readable media.

In an implementation, the architectures and functionalities depicted in the various previous figures may be implemented in the context of the processor 604, a graphics processor coupled to a communication interface 612, an integrated circuit (not shown) that is capable of at least a portion of the capabilities of both the processor 604 and a graphics processor, a chipset (i.e., a group of integrated circuits designed to work and sold as a unit for performing related functions, etc.).

Furthermore, the architectures and functionalities depicted in the various previous figures may be implemented in the context of a general computer system, a circuit board system, a game console system dedicated for entertainment purposes, an application-specific system. For example, the computing arrangement 600 may take the form of a desktop computer, a laptop computer, a server, a workstation, a game console, an embedded system.

Furthermore, the computing arrangement 600 may take the form of various other devices including, but not limited to a personal digital assistant (PDA) device, a mobile phone device, a smart phone, a television, etc. Additionally, although not shown, the computing arrangement 600 may be coupled to a network (e.g., a telecommunications network, a local area network (LAN), a wireless network, a wide area network (WAN) such as the Internet, a peer-to-peer network, a cable network, or the like) for communication purposes through an I/O interface 608.

It should be understood that the arrangement of components illustrated in the figures described are exemplary and that other arrangement may be possible. It should also be understood that the various system components (and means) defined by the claims, described below, and illustrated in the various block diagrams represent components in some systems configured according to the subject matter disclosed herein. For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

1. A method for training a neural network model in a computer system, the neural network model comprising a plurality of layers each comprising one or more neurons, the plurality of layers comprising at least one first layer and one last layer, each neurons being configured to perform forward propagation of one or more input values by applying weights to the one or more input values and generating an output value based on a function applied to the sum of the weighted input values, the one or more neurons of each layer, but the last layer, of the plurality of layers being connected with the one or more neurons of a consecutive layer, and the one or more neurons of each layer, but the first layer, of the plurality of layers being connected with the one or more neurons of a preceding layer, such that the output of a respective neuron of a preceding layer is used as an input value of the neurons of a consecutive layer connected with the respective neuron, the method comprising:
a forward propagation step including:
inputting initial input values to the neurons of the first layer; and
performing forward propagation from the one or more neurons of the first layer through the one or more neurons of the consecutive layers, until the one or more neurons of the last layer, to obtain output values of the one or more neurons of the last layer; and
a back propagation step including:
measuring errors between the output values and expected values of the one or more neurons of the last layer; and
for each layer, but the last layer, until the first layer, of the plurality of layers, measuring errors between the output values and expected values of the one or more neurons of the respective layer, performing back propagation by determining weight updates values for the weight of the neurons of the respective layer, based on the measured errors between the output values and expected values of the one or more neurons of the consecutive layer, and changing the weight values of the one or more neurons of the respective layer based on the weight update values,
wherein performing the back propagation comprises:
determining inhibited neurons and uninhibited neurons amongst the one or more neurons of the respective layer based on measurement of errors between the output values and expected values of the one or more neurons of the respective layer; and
changing the weight values only of the uninhibited neurons of the respective layer.

2. The method according to claim 1, wherein determining the inhibited and uninhibited neurons amongst the one or more neurons of the respective layer comprises:
using the measured errors between the output values and expected values to determine a contribution of each neuron of the one or more neurons of the respective layer of the plurality of layers to the output values and deciding whether a respective neuron is inhibited or uninhibited based on the contribution.

3. The method according to claim 1, further comprising:
inputting a plurality of sets of input values to the one or more neurons of the respective layer and performing forward propagation on the one or more neurons of the respective layer to obtain corresponding sets of output values of the one or more neurons of the respective layer; and
determining weight updates values for the weight of the one or more neurons of the respective layer and inhibited neurons and uninhibited neurons amongst the one or more neurons of the respective layer, based on measurement of errors between the sets of output values and corresponding sets of expected values.

4. The method according to claim 1, the neural network model comprising n layers, with n≥2, wherein the n layers are divided in a first group of layers gathering the first p layers, with 0<p<n, and a second group of layers gathering the last n-p layers, the method being performed separately on the first group of layers and on the second group of layers.

5. The method according to claim 4, wherein the neural network model is a model for image classification in the computer system, the sets of input values corresponding to image pixels values, a connexion path from one neuron of the one or more neurons of the first layer to one neuron of the one or more neurons of the last layer in the network corresponding to a channel from one input pixel value to one output pixel value,
wherein determining the inhibited neurons and the uninhibited neurons amongst the one or more neurons of the respective layer further comprises:
determining a two dimensional mask based on measurement of errors between the output values and expected values, wherein each element of the two dimensional mask corresponds to a neuron of the one or more neurons in the respective layer and comprising inhibition information, and
wherein propagating the weight updates values to change the weight values only of the uninhibited neurons of the respective layer comprises applying the mask to avoid the weights of the inhibited neurons and allow the weights of the uninhibited neurons to be changed depending on the corresponding inhibition information.

6. A computer system for training a neural network model, the neural network model comprising a plurality of layers each comprising one or more neurons, the plurality of layers comprising at least one first layer and one last layer, each neuron being configured to perform forward propagation of one or more input values by applying weights to the one or more input values and generating an output value based on a function applied to the sum of the weighted input values, the one or more neurons of each layer, but the last layer, of the plurality of layers being connected with one or more neurons of a consecutive layer, and the one or more neurons of any respective layer, but the first layer, of the plurality of layers being connected with one or more neurons of a preceding layer, such that the output of a respective neuron of one given layer is used as an input value of the neurons of the consecutive layer connected with the respective neuron, the computer system comprising
a forward calculation processor configured to:
allow inputting of initial input values to the one or more neurons the first layer; and
perform forward propagation from the one or more neurons of the first layer through the one or more neurons of the consecutive layers, until the one or more neurons of the last layer, to obtain output values of the one or more neurons of the last layer,
a backward calculation processor configured to:
measure errors between output values and expected values of the one or more neurons of the last layer,
for each layer, but the last layer, until the first layer, measure errors between the output values and expected values of the one or more neurons of the respective layer, and determine weight updates values for the weight of the one or more neurons of the respective layer, based on the measured errors between the output values and expected values of the one or more neurons of the consecutive layer, and change the weight values of the one or more neurons of the respective layer based on the weight update values,
wherein the backward calculation processor is further configured to:
determine inhibited neurons and uninhibited neurons amongst the one or more neurons of the respective layer based on measurement of errors between the output values and expected values of the respective layer, and
change the weight values only of the uninhibited neurons of the given layer.

7. The computer system according to claim 6, wherein the backward calculation processor is further configured to use the errors measured between the output values and expected values to determine a contribution of each neuron of the one or more neurons of the respective layer to the output values and to decide whether a neuron is inhibited or uninhibited based on the contribution.

8. The computer system according to claim 6, wherein the forward calculation processor is further configured to allow inputting of a plurality of sets of input values to the one or more neurons of the respective layer and to perform forward propagation on the one or more neurons of the respective layer to obtain corresponding sets of output values of the one or more neurons of the respective layer, and wherein the backward calculation processor is further configured to determine weight updates values for the weight of the one or more neurons of the respective layer and inhibited neurons and uninhibited neurons amongst the one or more neurons of the respective layer, based on measurement of errors between the sets of output values and corresponding sets of expected values.

9. The computer system according to claim 8, wherein the neural network model comprises n layers, with n≥2, wherein the n layers are divided in a first group of layers gathering the first p layers, with 0<p<n, and a second group of layers gathering the last n-p layers, and wherein the computer system is further configured to run iteratively the forward calculation processor and the backward calculation processor, separately on the first group of layers and on the second group of layers.

10. The computer system according to claim 9, wherein the neural network model is a model for image classification, the sets of input values corresponding to image pixels values, a connexion path from one neuron of the one or more neurons of the first layer to one neuron of the one or more neurons of the last layer in the network corresponding to a channel from one input pixel value to one output pixel value,
wherein the backward calculation processor is further configured to:
determine a two dimensional mask based on measurement of errors between the output values and expected values, wherein each element of the two dimensional mask corresponds to a neuron of the one or more neurons in the respective layer and comprising inhibition information, and
when propagating the weight updates values to change the weight values only of the uninhibited neurons of the respective layer, apply the mask to avoid the weights of the inhibited neurons and allow the weights of the uninhibited neurons to be changed depending on the corresponding inhibition information.

11. A computer-readable storage medium comprising instructions for training a neural network model in a computer system, the neural network model comprising a plurality of layers each comprising one or more neurons, the plurality of layers comprising at least one first layer and one last layer, each neuron being configured to perform forward propagation of one or more input values by applying weights to the one or more input values and generating an output value based on a function applied to the sum of the weighted input values, the one or more neurons of each layer, but the last layer, of the plurality of layers being connected with the one or more neurons of a consecutive layer, and the one or more neurons of each layer, but the first layer, of the plurality of layers being connected with the one or more neurons of a preceding layer, such that the output of a respective neuron of a preceding layer is used as an input value of the neurons of a consecutive layer connected with the respective neuro, wherein the instructions, when executed by a computer, cause the computer to perform:
a forward propagation step including:
inputting initial input values to the neurons of the first layer; and
performing forward propagation from the one or more neurons of the first layer through the one or more neurons of the consecutive layers, until the one or more neurons of the last layer, to obtain output values of the one or more neurons of the last layer; and
a back propagation step including:
measuring errors between the output values and expected values of the one or more neurons of the last layer; and
for each layer, but the last layer, until the first layer, of the plurality of layers, measuring errors between the output values and expected values of the one or more neurons of the respective layer, and performing back propagation by determining weight updates values for the weight of the neurons of the respective layer, based on measured errors between the output values and expected values of the one or more neurons of the consecutive layer, and changing the weight values of the one or more neurons of the respective layer based on the weight update values,
wherein performing the back propagation comprises:
determining inhibited neurons and uninhibited neurons amongst the one or more neurons of the respective layer based on measurement of errors between the output values and expected values of the one or more neurons of the respective layer; and
changing the weight values only of the uninhibited neurons of the respective layer.

12. The computer-readable storage medium according to claim 11, wherein determining the inhibited and uninhibited neurons amongst the one or more neurons of the respective layer comprises:
using the measured errors between the output values and expected values to determine a contribution of each neuron of the one or more neurons of the respective layer of the plurality of layers to the output values and deciding whether a respective neuron is inhibited or uninhibited based on the contribution.

13. The computer-readable storage medium according to claim 11, wherein the instructions, when executed by a computer, cause the computer to further perform:
inputting a plurality of sets of input values to the one or more neurons of the respective layer and performing forward propagation on the one or more neurons of the respective layer to obtain corresponding sets of output values of the one or more neurons of the respective layer; and
determining weight updates values for the weight of the one or more neurons of the respective layer and inhibited neurons and uninhibited neurons amongst the one or more neurons of the respective layer, based on measurement of errors between the sets of output values and corresponding sets of expected values.

14. The computer-readable storage medium according to claim 11, wherein the neural network model comprises n layers, with n≥2, wherein the n layers are divided in a first group of layers gathering the first p layers, with 0<p<n, and a second group of layers gathering the last n-p layers, the method being performed separately on the first group of layers and on the second group of layers.

15. The computer-readable storage medium according to claim 14, wherein the neural network model is a model for image classification in the computer system, the sets of input values corresponding to image pixel values, a connexion path from one neuron of the one or more neurons of the first layer to one neuron of the one or more neurons of the last layer in the network corresponding to a channel from one input pixel value to one output pixel value,
wherein determining the inhibited neurons and the uninhibited neurons amongst the one or more neurons of the respective layer further comprises:
determining a two dimensional mask based on measurement of errors between the output values and expected values, wherein each element of the two dimensional mask corresponds to a neuron of the one or more neurons in the respective layer and comprising inhibition information, and
wherein propagating the weight updates values to change the weight values only of the uninhibited neurons of the given layer further comprises:
applying the mask to avoid the weights of the inhibited neurons and allow the weights of the uninhibited neurons to be changed depending on the corresponding inhibition information.

16. The method according to claim 5 wherein the two dimensional mask comprises one or more zero values and one or more non-zero values, and the inhibited neurons are associated with the one or more zero values in the two dimensional mask at the respective layer of the plurality of layers, and the uninhibited neurons are associated with the one or more non-zero values in the two dimensional mask at the respective layer of the plurality of layers.

17. The computer system according to claim 10, wherein the two dimensional mask comprises one or more zero values and one or more non-zero values, and the inhibited neurons are associated with the one or more zero values in the two dimensional mask at the respective layer of the plurality of layers, and the uninhibited neurons are associated with the one or more non-zero values in the two dimensional mask at the respective layer of the plurality of layers.

18. The computer-readable storage medium according to claim 15, wherein the two dimensional mask comprises one or more zero values and one or more non-zero values, and the inhibited neurons are associated with the one or more zero values in the two dimensional mask at the respective layer of the plurality of layers, and the uninhibited neurons are associated with the one or more non-zero values in the two dimensional mask at the respective layer of the plurality of layers.
